(19) United States
(12) Patent Application Publication
(10) Pub. No.: US 2015/0291085 A1
(43) Pub. Date: Oct. 15, 2015

(54) ILLUMINATED TRANSLUCENT BODY PANELS AND METHODS THEREFOR

(71) Applicant: Kerry Manning, Parker, CO (US)

(72) Inventor: Kerry Manning, Parker, CO (US)

(21) Appl. No.: 14/683,902

(22) Filed: Apr. 10, 2015

Related U.S. Application Data
(60) Provisional application No. 61/977,757, filed on Apr. 10, 2014.

(51) Int. Cl. B60Q 1/26; B60Q 1/30; B60Q 1/32; B60Q 1/28

(52) U.S. Cl. CPC B60Q 1/2619; B60Q 1/2696; B60Q 1/28; B60Q 1/30; B60Q 1/323; B60Q 2400/50

(57) ABSTRACT

A vehicle body panel including a curved translucent panel having an interior surface and an exterior surface, a color layer disposed on at least a portion of the exterior surface, a blocking layer positioned between at least a portion of the color layer and the panel, and a light source attached to the interior surface.

### CROSS-REFERENCE TO RELATED APPLICATIONS

This application claims the benefit of U.S. Provisional Patent Application No. 61/977,757, filed Apr. 10, 2014, the disclosure of which is hereby incorporated herein by reference in its entirety.

### TECHNICAL FIELD

The present disclosure relates, in general, to vehicle bodies and panels, and more particularly to illuminated transparent and translucent vehicle body panels, such as those used in cars, trucks, aircraft, trains and boats.

### BACKGROUND

Vehicle bodies have traditionally been made of opaque materials, such as steel, aluminum, plastic, etc. that are formed to the desired shape and painted in the desired color. The body panels have openings for various parts, such as windows to allow visibility to the occupants, and for the many lights that are necessary for a road going vehicle. These lights include headlights, turn signals, brake lights, side markers, and reverse lights among other lights. These lights have discrete components within the light housing, including the bulbs/lamps, diffusers, lenses, and reflectors to name a few. A corresponding receptacle is cut or formed into the body panels in order to receive the light housings. Furthermore, because paint is applied to an external surface of the body panels, the paint is subject to damage from scratching, denting, and degradation due to ultraviolet light.

### SUMMARY

Some embodiments provide uniform transparent or translucent material body panels configured to allow lighting and/or illumination from within the inside of the vehicle or body panel.

The vehicle panels provided in the various embodiments include, without limitation, apparatuses, systems, and methods. Merely by way of example, a method might comprise one or more procedures, any or all of which are part of the system. Correspondingly, an embodiment might provide a body panel lighting system configured with features in accordance with methods provided by various other embodiments.

In some embodiments, a translucent vehicle body panel includes an exterior layer having a first external surface and a first internal surface. The exterior layer is the wall of the vehicle body panel that faces outwards from the vehicle (e.g., outboard) when coupled to the vehicle body. In some embodiments, the vehicle body panel can also have an interior layer having a second external surface and a second internal surface. The interior layer is the layer facing the interior of the vehicle (e.g., inboard), the wall of the vehicle body panel closer to the vehicle body. The exterior and interior layers are configured to allow light, from between the exterior layer and interior layer, or from behind the interior layer, to pass through exterior layer. In some embodiments, the vehicle body panel includes a feature mount and a bonded feature coupled to the feature mount. Bonded features include, but are not limited to traditional lights such as headlights, turn signals, brake lights, side markers, reverse lights.

Embodiments provide for new lighting systems for vehicles such as illuminating the entire vehicle, changing its color, displaying symbols or logos or other aesthetic features. The use of transparent material also provides for other features that are normally placed on an external surface of the vehicle to be protected and integrated. By applying paint, trim work, logos, insignia, and other bonded features to the interior, it is protected from damage by scratching, denting, and degradation due to ultraviolet light. The transparent surface can also be textured or have particular shapes formed into an exterior facing layer that, when painted, provides a unique appearance. Finally these design features also allow the exterior of a vehicle to be made from large unbroken surfaces for improve aesthetics and aerodynamics.

### BRIEF DESCRIPTION OF THE DRAWINGS

FIG. 1 is a cross sectional view of one of the embodiments depicting a translucent external layer of a vehicle body panel having a coating (paint) on the exterior surface;

FIG. 2 is a cross sectional view of one of the embodiments depicting a translucent vehicle body panel having a coating (paint) on the interior surface;

FIG. 3 is a cross sectional view of one of the embodiments depicting a translucent vehicle body panel having a coating (paint) on the interior surface that has a small opening allowing the light to be emitted unabated;

FIG. 4 is a cross sectional view of one of the embodiments depicting a translucent vehicle body panel having and object (such as insignia) adhered to the interior surface and then covered by a coating (paint) on the interior surface;

FIG. 5 is a cross sectional view of one of the embodiments depicting a vehicle body panel made from a translucent honeycomb material having coating (paint) on the exterior most surface;

FIG. 6 is a cross sectional view of one of the embodiments depicting a vehicle body panel made from a stiffened translucent material having a coating (paint) on the exterior most surface with a light embedded between the face-sheets;

FIG. 7 is a cross sectional view of one of the embodiments depicting a vehicle body panel made from a transparent material where the light is transmitted from the edge via total internal reflection until it reaches a significant changed in curvature;

FIG. 8 is a cross sectional view of one of the embodiments depicting a vehicle body panel made from a transparent material where the light is transmitted from the edge via total internal reflection until it reaches a formed feature;

FIG. 9 is a cross sectional view of one of the embodiments depicting a vehicle body panel having an opaque portion and a transparent window portion; and

FIG. 10 is a cross sectional view of one of the embodiments depicting a translucent vehicle body panel incorporating an electro-illuminating layer.

### DETAILED DESCRIPTION

Disclosed herein are illuminated translucent vehicle body panels. In an embodiment, one or more light sources can be affixed to the inside of the panel and controlled independently to serve the functions of one or more light features including but not limited to turn signals, brake lights, side markers, reverse lights or other lighting features. These lights are positioned inside the body panel and oriented towards, and approximately perpendicular to the external surface with the distance from the surface influencing the size and shape of the illuminated area. The controlled paint thickness and formulation selectively transforms the transparent panel to function as an opaque material as it blocks the transmission of low intensity light making the surface appear opaque under ambient lighting conditions but allows transmission of the higher intensity lighting from inside or within the panel. The paint thickness can be applied differently in specific locations in order to allow the light to be transmitted in only specific shapes and areas, such as arrows to signal the direction of a turn.

In the following description, for the purposes of explanation, numerous specific details are set forth in order to provide a thorough understanding of the described embodiments. It will be apparent to one skilled in the art, however, that other embodiments may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment, as other embodiments may omit such features.

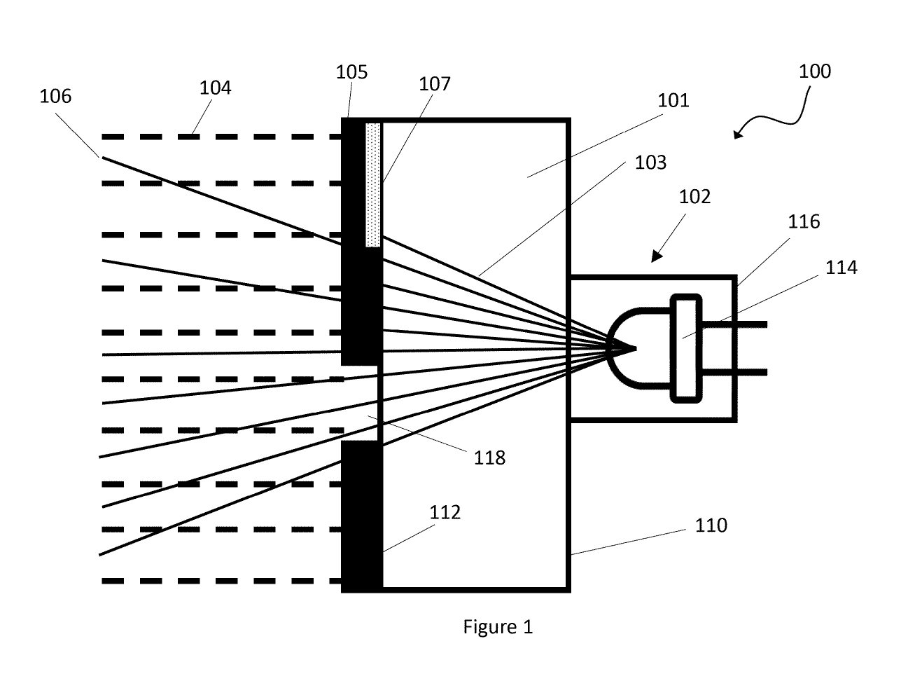

FIG. 1 illustrates a cross-section of an exterior layer of a body panel 100 according to a representative embodiment. Body panel 100 includes a translucent plastic (e.g., polycarbonate) panel 101 with a light source 102 that can be attached to an interior surface 110 (e.g., inboard of a vehicle) of the plastic panel 101. In this embodiment, the light source comprises a light emitting diode (LED) 114 having an associated mount 116. The mount 116 can be attached by bonding (e.g., adhesive), welding (thermally or ultrasonically), or fastening with bolt screws, rivets, or any suitable fastener. Although the embodiments herein are generally described with respect to light sources in the form of LED lights, other light emitting structures can be used. For example, incandescent lights, electroluminescent panels, fluorescent lights, gas discharge lights, or any other suitable type of light emitting devices. In addition, multiples, series, or arrays of light emitting structures can be used. In some embodiments the light source is spaced apart from the panel. It should also be understood that light sources can comprise head light, tail light, brake light, and turn signal assemblies. For example, a head light assembly having a bucket can be attached to the panel as explained above with respect to LED 114 and mount 116, wherein the head light bucket is analogous to mount 116. In some embodiments, the plastic panel 101 is transparent and the paint layer 105 is masked to create an opening (e.g., opening 118) suitable for the head light to project light through the body panel 100. It should be appreciated that combinations of color layers (interior or exterior), openings, and blocking layers can be used in various combinations.

The exterior surface 112 (e.g., toward the outboard of a vehicle) of body panel 100 has color layer in the form of a paint layer 105 that covers selected areas of the panel. In this embodiment, the paint layer 105 covers the entire exterior surface 112. The thickness and opacity of the paint layer 105 is controlled relative to the intensity of the light source 102 such that the light emitted 103 from the light source 102 is sufficient to travel through panel 101 and the paint layer 105 to exit the exterior of the vehicle as visible light 106. The paint layer 105 is also controlled to have sufficient thickness and opacity so that ambient light 104 is absorbed and the body panel 100 appears to be opaque under normal ambient light conditions.

In some embodiments, an additional blocking layer of paint 107 is positioned between the paint layer 105 and the plastic panel 101. The blocking layer 107 is an opaque layer that prevents emitted light 103 from exiting the exterior of the vehicle. Accordingly, the blocking layer 107 can be applied with masking to produce an opening or aperture in a desired shape, such as a chevron for use as a turn signal indicator. In some embodiments, the blocking layer is another layer of the same material used for the paint layer 105. In other embodiments, the blocking layer 107 is a different material or color than the paint layer 105.

As presented in this document “transparent” has the meaning of allowing the specular transmission of light allowing light to pass through so that objects behind can be distinctly seen with minimal distortion. And, where “translucent” means that the material, or layers of material, allows light, but not detailed images, to pass through; also known as semi-transparent. Any references to translucent are known to apply to either transparent or semi-translucent embodiments. “Opaque” has the meaning of appearing to block all light from passing through the material or layers of material. “Opacity” refers to the degree to which a material or paint is opaque. In other words, opacity refers to a material's transmittance or ability to pass light therethrough.

In some embodiments, the paint layer 105 can be applied to the surfaces of the panel 101, at a controlled thickness of between approximately 0.0005 inches and approximately 0.010 inches. In other embodiments, the paint layer can have a thickness between approximately 0.003 inches and approximately 0.015 inches. In some embodiments, the paint layer can have a thickness between approximately 0.001 inches and approximately 0.030 inches. In other embodiments, the paint layer can have a thickness between approximately 0.0005 inches and approximately 0.050 inches. The thickness of the paint can be controlled with known spray technology as well as robotic application of paint. Various selected areas to be painted can also be layered to control thickness. Areas of the panel 101 as well as areas of painted surfaces can be masked. In some embodiments, vehicle body panels can be masked from the paint in areas that are to remain transparent or translucent by a temporary film or rigid mask that is held in place either by temporary adhesive, static cling, vacuum, or magnets. This allows for the installation of features to occur at a later point of the manufacturing process. By masking the desired area, a transparent body panel allows the uninterrupted specular transmission of light in certain instances, for example the light of headlights to pass through, while also allowing the paint, insignia, chrome trims, and other features to remain visible. These transparent areas also allow features such as license plates to be installed under the body panel but still remain visible. In some embodiments, the color layer and/or blocking layer is in the form of a film that is applied to surfaces of the panel. In some embodiments, the film is applied to a panel prior to thermoforming the panel's shape. Applying the film prior to thermoforming helps control the thickness of the color layer. Furthermore, it should be appreciated that the color layer can be any color including for example and without limitation black and white.

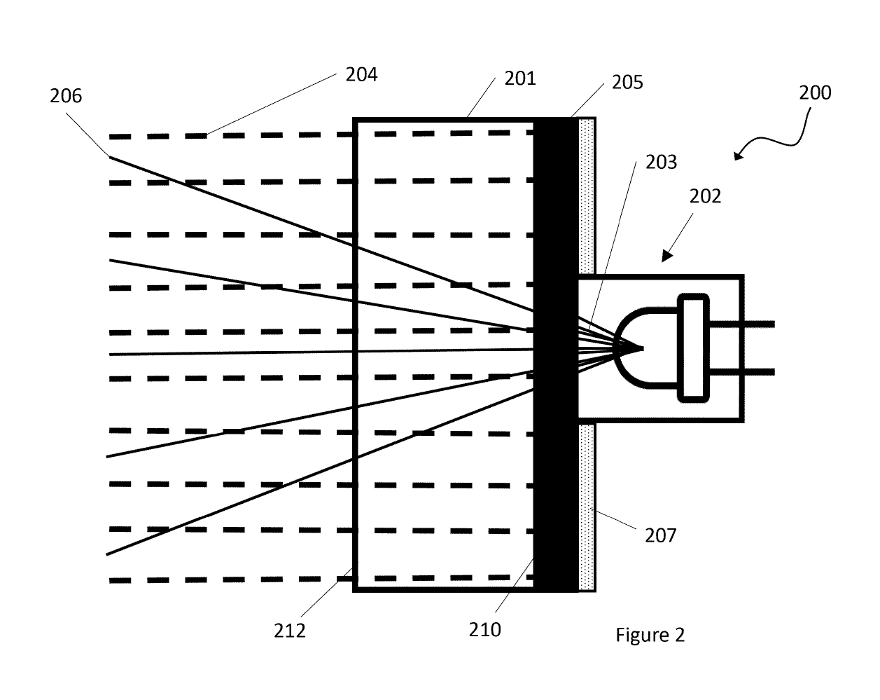

FIG. 2 illustrates a cross-section of an exterior layer of a body panel 200 according to a representative embodiment. The body panel 200 includes a transparent plastic panel 201 with a light source 202 that is attached to the panel 201 inboard of paint layer 205. In this embodiment, the entire interior surface 210 has paint layer 205 that covers all the areas of the panel. The thickness and opacity of the paint layer 205 is controlled relative to the intensity of the light source 202 such that light emitted 203 from the light source 202 is sufficient to travel through the paint layer 205 and the panel 201 to exit the exterior of the vehicle as visible light 206. The paint layer 205 has sufficient thickness and opacity so that ambient light 204 is absorbed and the body panel 200 appears to be opaque under normal ambient conditions. In some embodiments, an additional paint layer, such as reflective coating 207, can also be applied to the inboard side of the paint layer 205 so that light is reflected back toward the exterior surface 212 enhancing the brightness of the lighting system.

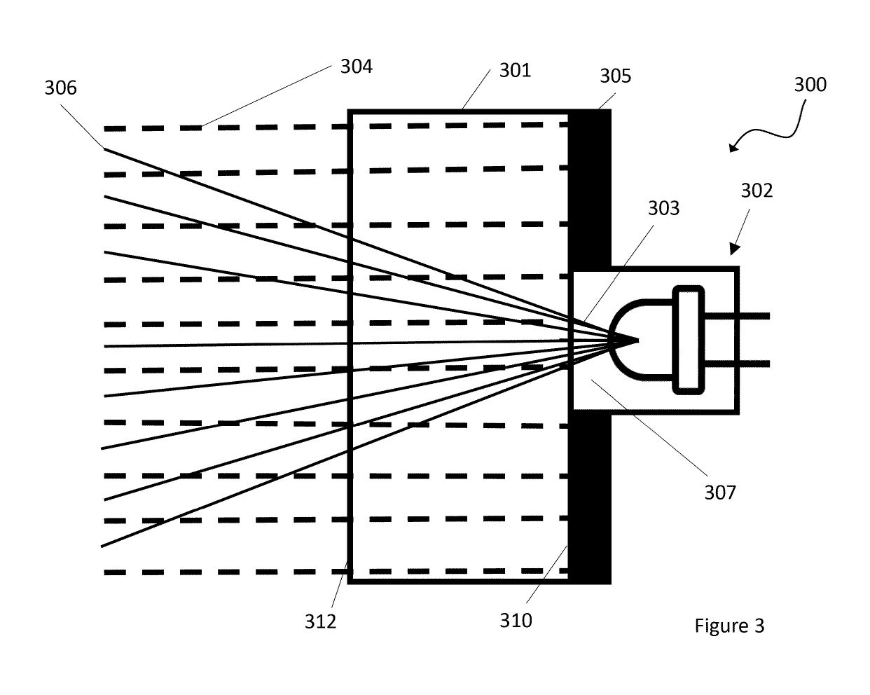

FIG. 3 illustrates a cross-section of an exterior layer of a body panel 300 according to a representative embodiment. The body panel 300 includes a transparent plastic panel 301 with a light source 302 that is attached to the interior surface 310 of the panel 301. The remainder of the interior surface has an opaque paint layer 305 that covers all the areas of the panel that are not intended to be illuminated. The opening 307 in the paint layer 305 allows the light emitted 303 from the light source 302 to continue to the exterior of the vehicle as visible light 306. The opening 307 can be sized depending on the application. In some embodiments, multiple openings can be sized (e.g., 1 mm or 2 mm diameter) to correspond to an array of small LEDs. In some embodiments, the openings can be larger to accommodate a headlight, for example. The paint 305 has sufficient thickness and opacity so that the ambient light 304 is absorbed and the panel appears to be opaque. Any features (e.g., light source 302) attached to the surfaces of panel 301 mask the surface from the paint, so as to keep the feature visible from the exterior of the vehicle.

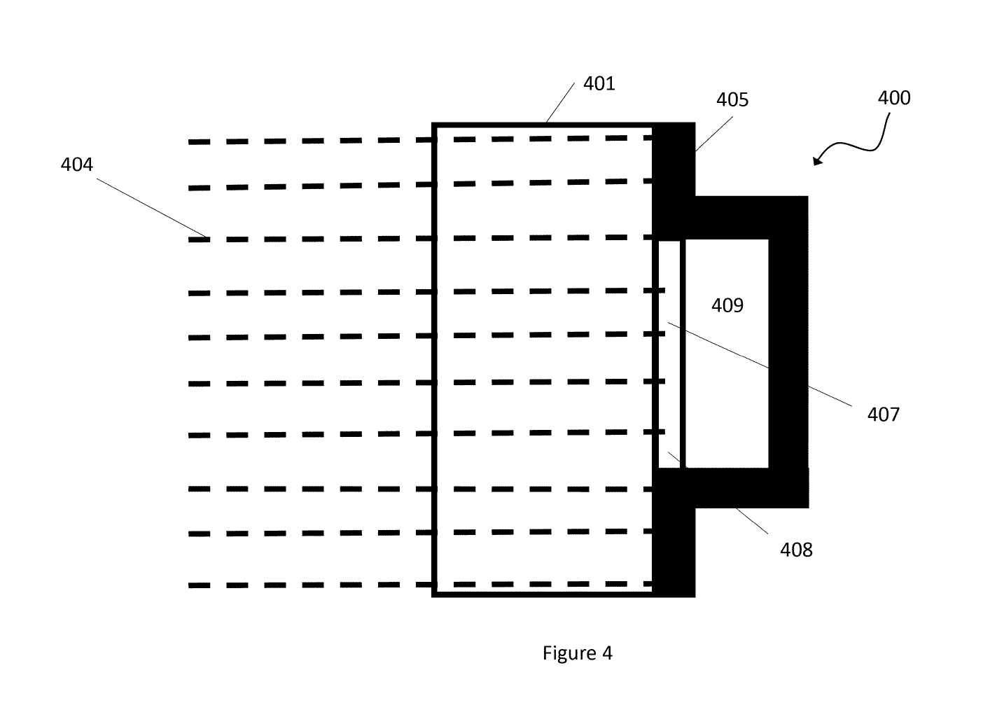

FIG. 4 illustrates a cross-section of an exterior layer of a body panel 400 according to a representative embodiment. The body panel 400 includes a transparent plastic panel 401 with an aesthetic feature 409, such as an insignia, that is directly adhered to the interior surface 410 of the panel with a transparent adhesive 408. The entire interior surface of the panel is then covered with an opaque paint layer 405. The resulting opening 407 in the paint left by the adhesive 408 and aesthetic feature 409 acts as a mask leaving the underlying feature 409 visible from the exterior under ambient light 404.

Large vehicle body panels often require additional strength and stiffness. In one embodiment, additional stiffness is achieved by adding core and face-sheets, to the inside and/or internal surfaces of the panel, after paint has been applied. This transforms the translucent panels into a stiffened sandwich construction while maintaining the aesthetics of the panel. Additionally lighting may be applied prior to the core application which allows the translucent properties of the panel to be maintained, allowing the lighting and signaling described above. In some embodiments, the core material can be made from traditional opaque core materials such as foam and honeycomb.

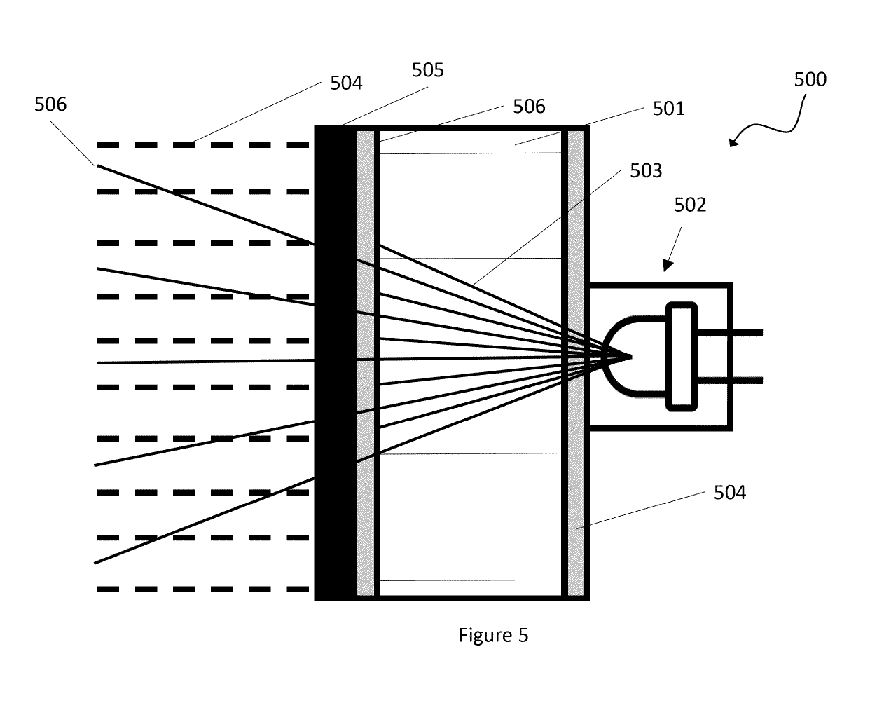

FIG. 5 illustrates a cross-section of an exterior layer of a body panel 500 according to a representative embodiment. The body panel 500 includes a translucent reinforcing core material 501, such as polypropylene honeycomb, and translucent interior and exterior plastic face-sheets 504 and 506, respectively. A light source 502 is attached to the interior face-sheet 504. The exterior face-sheet 506 has a paint layer 505 that covers all the areas of the panel. The thickness and opacity of the paint layer 505 is controlled relative to the intensity of the light source 502 such that light emitted 503 from the light source 502 is sufficient to travel through the face-sheets 504, 506, the core material 501, and the paint layer 505 to exit the exterior of the vehicle as visible light 506. The paint layer 505 has sufficient thickness and opacity so that ambient light 504 is absorbed and the body panel 500 appears to be opaque under normal ambient conditions.

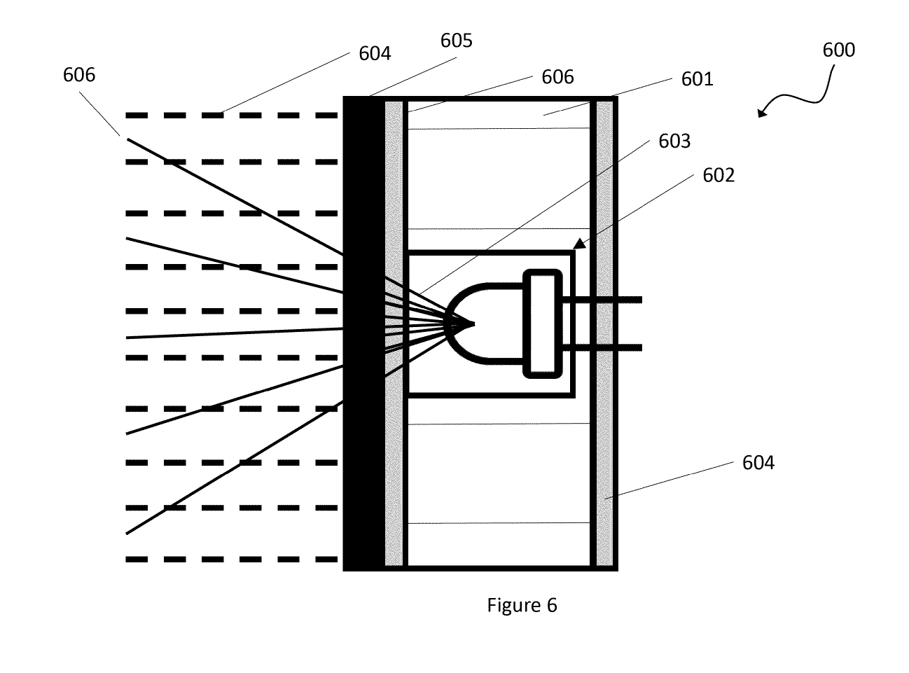

FIG. 6 illustrates a cross-section of an exterior layer of a body panel 600 according to a representative embodiment. The body panel 600 includes a core material 601 such as honeycomb, and interior and exterior translucent plastic face-sheets 604 and 606 respectively. A light source 602 that is embedded inside the core 601. The exterior face-sheet 606 has a paint layer 605 that covers all the areas of the panel. The thickness and opacity of the paint layer 605 is controlled relative to the intensity of the light source 602 such that light emitted 603 from the light source 602 is sufficient to diffusely travel through the exterior face-sheet 606, the core material 601, and the paint layer 605 to exit the exterior of the vehicle as visible light 606. The paint layer 605 has sufficient thickness and opacity so that ambient light 604 is absorbed and the body panel 600 appears to be opaque under normal ambient conditions.

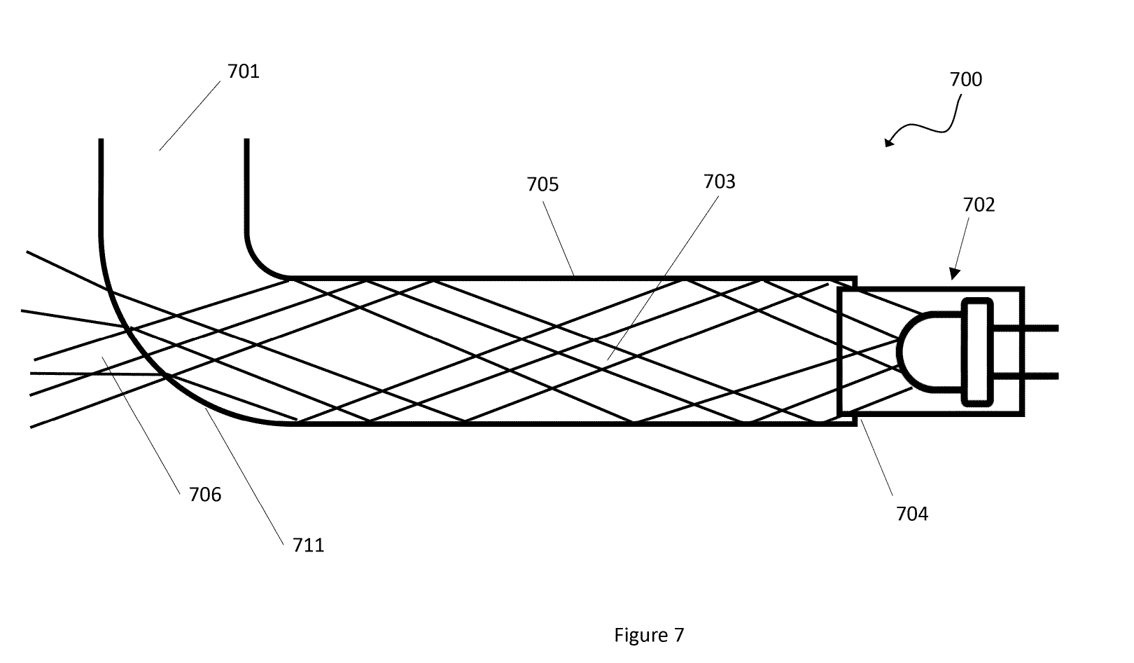

FIG. 7 illustrates a cross-section of an exterior layer of a body panel 700 according to a representative embodiment. The body panel 700 includes a transparent plastic panel 701 with a light source 702 installed at the edge 704 of the plastic panel 701 which directs light 703 emitted from the light source 702 along the length of the panel. The index of refraction of the plastic 701, the paint layer 705, is selected so that when the light is inserted tangential to curvature of the panel)(±15° the light 703 remains trapped inside the plastic via total internal reflection. The light 703 continues to be transmitted down the length of the panel 701 until it reaches a local change in refraction or radius of curvature, such as a corner or crease 711 in the body panel. At this point the angle of the light 703 exceeds the maximum reflection angle so that it is transmitted externally as visible light 706. The entire exterior layer has a paint layer 705 that covers the entire interior and/or exterior surfaces of the panel. The thickness and opacity of the paint layer 705 is controlled in the illuminated area and the intensity of the light emitted 703 from the light source 702 is sufficient to continue to the exterior of the panel 700.

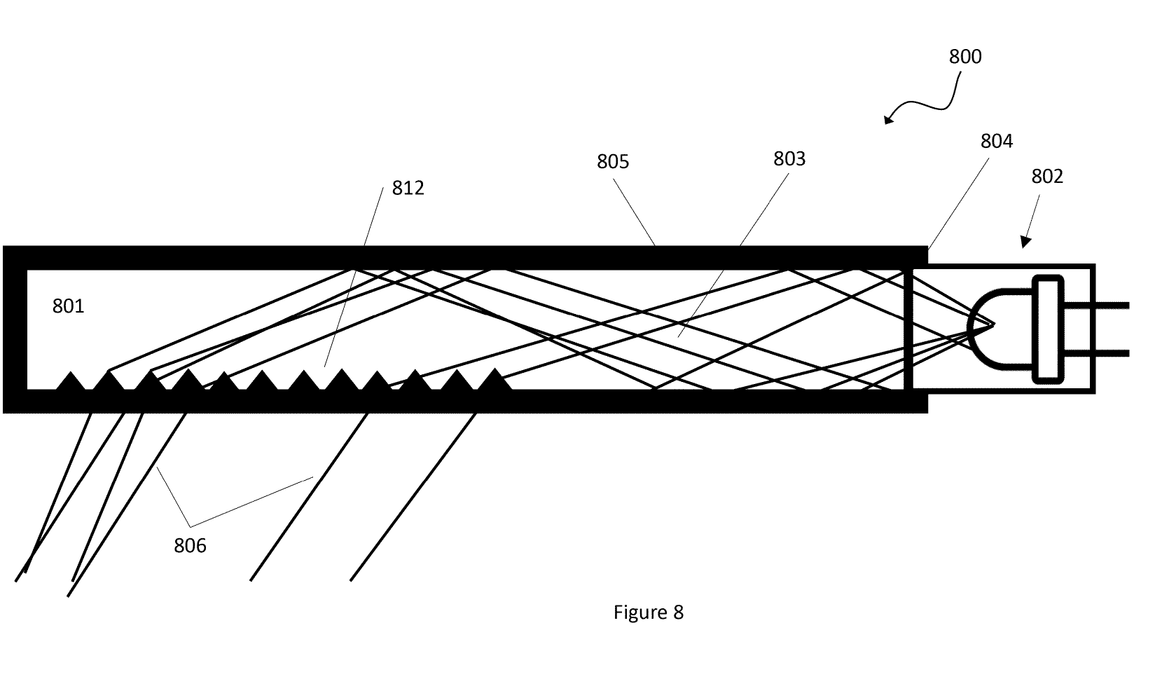

FIG. 8 illustrates a cross-section of an exterior layer of a body panel 800 according to a representative embodiment. Body panel 800 includes a transparent plastic sheet 801 with a light source 802 that is installed at the edge 804 of the panel 801 which directs the light 803 emitted from light source 802 along the length of the panel. The index of refraction of the plastic 801 and the angle of the light is controlled along with the curvature of the panel so that the light 803 remains trapped inside the plastic via total internal reflection. The light 803 continues to be transmitted down the length of the panel until it reaches features 812, such as small ridges that are embossed into the exterior surface of the panel 801. These features can be formed during the manufacturing process (e.g., molding or machining) or through secondary operations, such as grit blasting. At this point the angle of the light 803 exceeds the maximum reflection angle so that it is transmitted externally as visible light 806. The entire surface, either interior and or exterior has a paint layer 805 that covers all the areas of the panel. The thickness and opacity of the paint layer 805 is controlled in the illuminated area and the intensity of the light emitted 803 from the light source 802 is sufficient to continue to the exterior 806 of the body panel 800. The paint layer 805 has sufficient thickness and opacity so that the ambient light is absorbed and the panel appears to be opaque under normal ambient conditions.

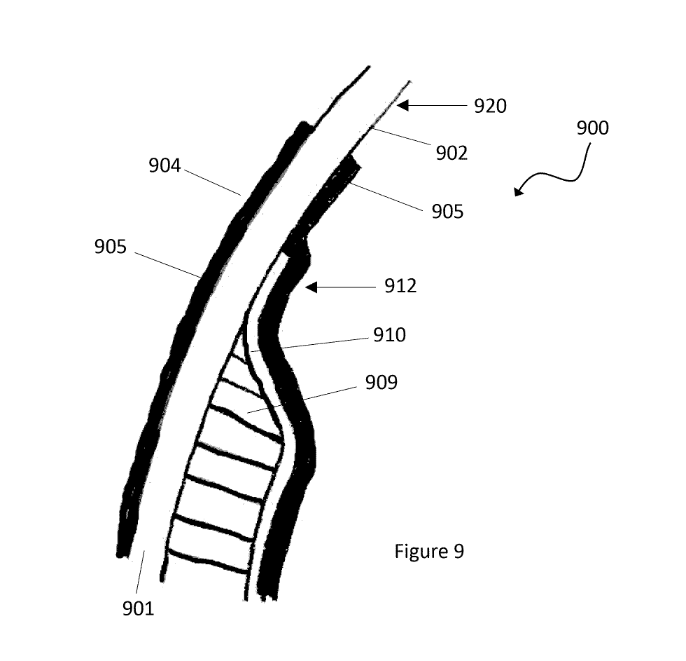

FIG. 9 illustrates a cross-section of an exterior layer of a body panel 900 according to a representative embodiment. Body panel 900 serves as an opaque body panel and a fixed window of a vehicle, for example. The body panel 900 includes a transparent plastic panel 901, reinforcing core material 909, such as honeycomb, and a face-sheet 910. The core material 909 is bonded or adhered to the interior surface 902 of panel 901. Face-sheet 910 overlays core material 909 and is adhered to the core material. Face-sheet 910 is also adhered to the interior surface 902 around a peripheral margin 912 of the core material 909. The panel includes a paint layer 905 that covers all the areas of the panel intended to be opaque. However, in the areas intended to serve as a window portion 920, the panel 901 is masked to leave the area transparent. In some embodiments, the masked areas can include small side windows, to entire roofs or windshields. The paint layer 905 has sufficient thickness and opacity so that the ambient light 904 is absorbed and the panel appears to be opaque under normal ambient conditions.

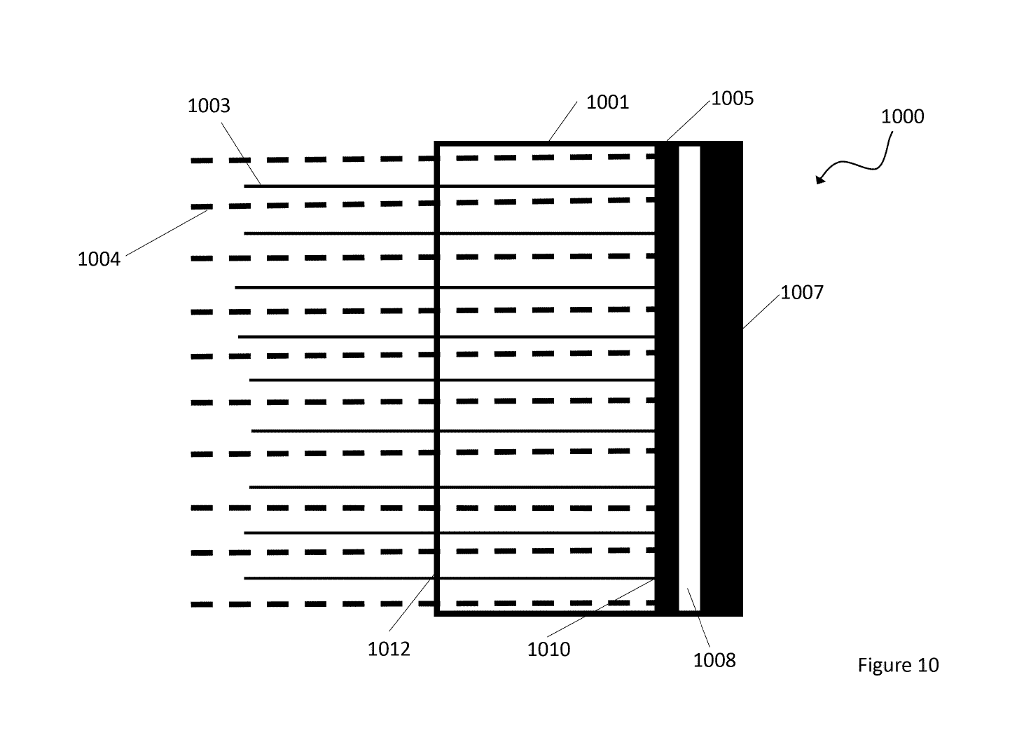

FIG. 10 illustrates a body panel 1000 according to a representative embodiment. The body panel 1000 includes a transparent panel 1001 with a paint layer 1005 applied to the interior surface 1010. An electro-illuminating layer 1008 is applied to the paint layer 1005. The thickness and opacity of the paint layer 1005 is controlled in the illuminated area and the intensity of the light emitted 1003 from the electro-illuminating layer 1008 is sufficient to continue through the exterior surface 1012 of the body panel 1000. The paint layer 1005 has sufficient thickness and opacity so that the ambient light 1004 is absorbed and the panel appears to be opaque under normal ambient conditions. Body panel 1000 also includes a reflective layer of paint 1007 positioned inboard of the electro-illuminating layer 1008 that serves to help direct the light from the electro-illuminating layer toward the exterior surface 1012 of the panel 1000. The electro-illuminating layer can comprise electroluminescent strips, panels, lamps, cords, coatings and/or paints, for example. Suitable electroluminescent panels are available from LuminousFilm of Shreveport, La. Suitable electroluminescent coatings are available from Darkside Scientific of Akron, Ohio and marketed under the LumiLor™ brand.

It should be appreciated that the disclosed technology can similarly be applied to the interior compartment of a vehicle in order to serve purposes such as interior illumination, entertainment, ambient mood lighting, or as a visual notification to the driver, such as activation of a turn signal or a vehicle located in a blind spot. It should also be understood that body panels can include for example and without limitation, fenders, bumpers, doors, hoods, trunk covers, roofs, floor pans, and the like. In addition, it should be appreciated that the disclosed body panels can be used on any suitable vehicle such as for example and without limitation automobiles, boats, motorcycles, tractor-trailers, airplanes, etc. Furthermore, the disclosed panels can be used in any other suitable application including for example and without limitation furniture, appliances, artwork, walls, doors, etc.

From the foregoing, it will be appreciated that specific embodiments of the disclosed technology have been described herein for purposes of illustration, but that various modifications may be made without deviating from the technology. For example, in one embodiment, a method of fabricating a large translucent body panel includes forming transparent plastic into a desired shape with the use of heat and pressure. The clear plastic is heated to make it formable and then differential pressure is applied to force the plastic against a mold with the desired shape, using techniques that create a vacuum between the mold and plastic, or pressure to press the plastic against the mold, or a combination of these and/or other techniques. Once cooled, the plastic retains the desired shape.

In some embodiments, light source mounts can be created in the vehicle body by creating a separate light source mounting structure (e.g., headlight bucket), or by forming the light source mount with the mold. In some embodiments, the mounts can be substantially flush with the surface of the vehicle body panel. In other embodiments, the mounts can be merely areas of the vehicle body panel indicated or created for certain features. Features such as headlights, chrome trims, and insignia are bonded to an internal surface of the panel with a transparent adhesive, or to mounting structures within the translucent body panel.

In one embodiment, a side mirror housing created all or primarily from translucent materials can be configured as a turn signal. Rather than using a discrete light housing, side mirror housing may be injection molded from a translucent or transparent material that has the desired external shape and the internal shape is configured with textures and refractive patterns for functional and aesthetic purposes. The thickness and transmittance of the translucent vehicle body panel is controlled to achieve an appearance that is opaque under brightly lit conditions, but allows a controlled transmission of light to pass through from within the housing. In one embodiment, colored LEDs or other lighting devices are positioned in the interior so that when they are turned on the entire side mirror housing is illuminated.

In another embodiment, LEDs or other lighting devices are positioned throughout the sides of the vehicle which comprise translucent vehicle body panels to function as a turn signal. Thus, the significant portion or portions of the vehicle flashes yellow when the LEDs are illuminated providing superior signaling to motorists by virtue of having a larger illuminated area (0.5-15 square meters) then current state of the art turn signals which are typically only 50-500 square centimeters.

For signaling at the rear of the vehicle, a large portion of the rear maybe illuminated providing superior signaling to motorists by virtue of having a larger illuminated area then current state of the art rear signals which are typically only 100-500 square centimeters. In one embodiment, the rear of the vehicle is made up of one or more body panels that are translucent and a grid of red or multi-color LEDs or other lighting devices are affixed to an internal surface of the interior layer of the panel. When indicating a turn, specific lights are illuminated yellow. In one embodiment, the yellow illuminated lights form a chevron pattern in the direction of a turn, and may move or flash sequentially to indicate the direction of the turn. To signal braking, a significant portion of the vehicle body panels at the rear of the vehicle may be illuminated red. This provides superior signaling to motorists by virtue of having a larger illuminated area of 0.5-30 square meters. The use of this lighting system enables the size shape and intensity of the signal to be varied depending on various factors such as braking intensity, and acceleration, both lateral and forward.

In some embodiments, the color of the light sources may be adjusted based on the color of the paint used on the exterior of the vehicle. This may be necessary depending on the paint color and the desired color of illumination. Different color paints transmit different wavelengths of light better than others. In order to account for this, the color of the light source can be adjusted so as to achieve the desired output color. In one embodiment, this can be accomplishing by the use of RGB (Red, Green, Blue) LEDs where the light source color can be readily adjusted.

In one embodiment, short distance illumination, such as the reverse light is achieved and signaled by illuminating all the colors of the multi-colored LEDs to produce a full spectrum white light that illuminates with maximum intensity. In some embodiments, the panel is translucent, but not transparent. Thus, the translucent vehicle body panel provides a diffuse light that is functional over the short distances that are applicable when a vehicle is reversing.

In another embodiment the panels are composite made from translucent plastic honeycomb that may be flat or formed into the desired shape by heat and/or pressure. The external surface of the honeycomb is covered by a thin layer that is adhered to the honeycomb before or after the shape forming with LEDs that are embedded into the honeycomb with an opaque or reflective plastic layer on the interior surface of the panel closing out the composite panel.

To stiffen the translucent material, reinforcements may be applied to all or part of the panel. Reinforcements include, but are not limited to, composites such a fiberglass or carbon fiber may be applied, as well as thin metals. In some embodiments, reinforcements are applied after paint has been applied to the internal surfaces of the vehicle body panel, hiding the reinforcements from view from the outside. In other embodiments, reinforcements are applied directly to the vehicle body panel to remain in view.

The reinforcement can be applied in several ways. In one embodiment, the reinforcements are applied via wet lamination to an already formed body panel. Through this technique, the reinforcement easily takes the shape of the formed vehicle body panels and can be applied to translucent or already painted surfaces. In another embodiment, the reinforcement can be made to the desired shape separately and then secondarily bonded to the formed vehicle body panel. In yet other embodiments, the composite reinforcement may be co-cured along with the forming of the vehicle body panel. In this process, the heat and forming that is used to achieve the desired vehicle body panel shape is also used to cure the composite. This process can include the use of a secondary thermoplastic or thermoset resin system.

In addition to the desirable stiffness and strength of the reinforcement, the translucent vehicle body panel also protects the reinforcement. For example, it is currently very desirable to have carbon fiber visible on a vehicle. Thus, the vehicle body panel can be reinforced using carbon fiber, and the vehicle body panel would protect it from scratches and damage from UV light.

In some embodiments, the entire exterior of a vehicle could be made from translucent white panels. In one embodiment, multi-colored Red, Green, and Blue (RGB) LEDs are affixed to an internal surface of the body panels. These LEDs are configured to illuminate portion or portions of an automotive vehicle body panel, having the light disperse along the surface of the vehicle body panel so that they produce a substantially uniform illumination of the vehicle body panel. In some embodiments, these lights can be independently controlled for intensity and wavelength (color) so that the vehicle body panel can exhibit different colors and different visual effects. Visual effects can include, but are not limited to, producing a relatively low illumination of the same color to make the white vehicle appear colored depending on the driver's taste. The LEDs are controlled by a system that would measure the ambient lighting and adjust the intensity of the light accordingly. Other visual effects include changing the color and intensity of the illumination to form different patterns, images, text, or video.

In another embodiment, the light for signaling is transmitted to the desired location via total internal reflection. In this method the body panels are made from transparent plastic and the lights are positioned at a nearby edge. The lights are largely unidirectional (as is typical for LEDs) and the emitted light is directed principally parallel to the panel surface and in the direction of the desired signal. The angle of the light combined with the difference in the index of refraction between the air and the plastic create a phenomenon known to those skilled in the art of optics as total internal reflection. The light is transmitted nearly perfectly inside the body panel until it reaches a point where the light intersects the surface of the panel at too great of an angle. The exact angles varies depending on the material used but would typically be between 5 and 10 degrees when measure tangential to the panels surface. At these locations the light would be emitted to the inside and or outside of the panel. Coatings can be applied to either surface that change the index of refraction in order to control the light being emitted towards the exterior rather than just the interior. In one embodiment the desired location of the signal has a sharp curvature change so that the emitted light is intense and localized and has no discernable effects when not in use. It may be desirable to allow for signal emission in areas without a change in the global curvature of the body panel. In this case the total internal reflection is broken by small localized changes such as a rough surface texture (grit blasting), tight crease in the panel, or a series of steps imbedded in the surface which would also function to redirect the emitted light, such as a fresnel lens. These features would likely be visible even when the signal was not illuminated.

In some embodiments, the translucent panels can take on a metallic appearance. For example, some vehicle bodies comprise polished metal, such as aluminum or stainless steel, and some vehicle bodies are plated with metals such as gold or silver. This has never been practical because the metals are easily damaged by dents scratches or corrosion. With the use of the translucent vehicle body panels, the metal can be applied to the external surface of the interior-facing layer of the vehicle body panel. In this configuration, the clear panel protects the metal. The metal could be used in place of paint in any of the embodiments described in this document. In some embodiments, metal plating could be applied by adhesive, chemical and or electrical or vapor deposition, flame arc or ion spraying. To protect the metal from corrosion or damage after it is applied, a paint or similar coating can be applied over the interior most surface. This would also protect the metal (or any of the atheistic coatings) from chips and scratches that might occur from road debris, particularly around the wheels.

Additional representative embodiments are provided in the following examples:

1. A vehicle made from large body translucent panels comprising:
an exterior layer having a first external surface and a first internal surface, wherein the first external surface and the first internal surface are configured to allow light, from behind the internal surface, to pass through both the internal surface and external surface.
2. Where the panels are illuminated by lights that are below external surface of the exterior layer and where the majority of the external panel appears opaque in ambient lighting conditions by:

a. The application of paint having the desired thickness and opacity and the use of lights that will overcome the limited transmission through the thin paint
i. Where the paint is applied to the interior surface of the exterior layer
ii. Where the paint is applied to the external surface of the exterior layer
iii. Where the opaque paint has a thickness from 0.003 to 0.015
iv. Where the opaque paint has a thickness from 0.001 to 0.030
v. Where the opaque paint has a thickness from 0.0005 to 0.050

b. Where the light from internal lights is allowed to be transmitted to the exterior through small openings left in the opaque paint where such openings are small so as to be visually unobtrusive when unilluminated but large enough to allow the light to illuminate the exterior surroundings

c. Where transparent exterior surface of the body panel is illuminated from an edge with the light primarily parallel to the surface and light remains inside the panel by means of total internal reflection until the outer surface radius of curvature is changed so that index of refraction is exceeded and the light is emitted to the exterior of the surface.

3. Where the exterior illumination is achieved with an array of lights that can be activated in different patterns, colors and intensities in order to several the many functions of a vehicle

a. Where the lights are multicolor LEDs

b. Where the light source is a layer of electroluminescent applied to the first internal surface of the exterior layer and where a reflective paint is applied on the interior surface of the electroluminescent layer in order to redirect the light to the exterior vehicle.

c. Where the function of the illumination is to signal a turn by illuminating a large portion of the rear of the vehicle red

d. Where the function of the illumination is to signal a turn by periodically illuminating a large portion of the side and or rear of the vehicle
i. Where the illumination is done in a pattern, such as, but not limited to a chevron that indicates the direction of the turn
ii. Where the illumination move across the vehicle exterior in a sequential manner to indicate the direction of the turn

e. Where the function of the illumination is to signal driving in reverse and providing illumination for the driver by illuminating a large portion of the rear of the vehicle white

4. Where the vehicle head lights are located beneath the exterior layer and the desired section of the panel is left unpainted so that the specular light and illuminate the surroundings
5. Where the exterior layer of the vehicle is translucent to allow features that lie beneath the exterior to be visible from the outside

a. wherein the bonded feature includes an insignia, logo, image, video, or text

b. wherein the feature is metal plating is applied to the first internal surface
i. Where the metal application is via ion deposition
ii. Where the metal application is via flame spraying
iii. Where the metal application is via chemical deposition

c. wherein the reinforcements are laminated directly to the first internal surface of the exterior layer

6. A translucent body panel comprising:

an exterior layer having a first external surface and a first internal surface, wherein the first external surface and the first internal surface are configured to allow light, from behind the internal surface, to pass through both the internal surface and external surface.

7. The translucent vehicle body panel of example 6 further comprising:

a feature mount; and

a bonded feature coupled to the feature mount.

8. The translucent vehicle body panel of example 7, wherein the feature mount is located on the first internal surface.
9. The translucent vehicle body panel of example 8, wherein the bonded feature includes an insignia, logo, image, video, or text.
10. The translucent vehicle body panel of example 8, wherein the bonded feature is a light source.
11. The translucent vehicle body panel of example 10, wherein the light source is configured to produce a predetermined visual effect.
12. The translucent vehicle body panel of example 10, wherein the light source is configured to correspond to braking of a vehicle, wherein the size and or intensity of illumination produced by the light source is based on the amount of deceleration of the vehicle.
13. The translucent vehicle body panel of example 6 further comprising a layer of paint, the layer of paint coating the first internal surface.
14. The translucent vehicle body panel of example 6 further comprising metal plating, wherein the metal plating is applied to the first internal surface.
15. The translucent vehicle body panel of example 6, further comprising reinforcements coupled to the exterior layer.
16. The translucent vehicle body panel of example 15, wherein the reinforcements are bonded directly to the first internal surface.
17. The translucent vehicle body panel of example 15, wherein the reinforcements are bonded to a layer of paint on the first internal surface.
18. The translucent vehicle body panel of example 15, wherein the reinforcements comprise a core and face sheet.
19. The translucent vehicle body panel of example 6, further comprising an interior layer having a second external surface and a second internal surface, wherein the exterior layer and interior layer are configured to allow light, from between the exterior layer and interior layer, or from behind the interior layer, to pass through exterior layer.
20. A vehicle comprising:

a translucent vehicle body panel coupled to an exterior part of the body, the vehicle body panel comprising an exterior layer having a first external surface and a first internal surface, wherein the first external surface and the first internal surface are configured to allow intended light, from behind the internal surface, to pass through both the internal surface and external surface.

21. The vehicle of example 20, wherein the translucent vehicle body panel further comprises:

a feature mount; and

an attached feature coupled to the feature mount.

22. The vehicle of example 21, wherein the translucent vehicle body panel houses a turn signal, wherein the attached feature is a turn signal.
23. The vehicle of example 21, wherein the translucent vehicle body panel houses a brake light, wherein the attached feature is a brake light.
24. The vehicle of example 21, wherein the attached feature is a light emitting diode light source, wherein the light emitting diode light source is further configured to produce a predetermined visual effect on the vehicle body panel.
25. The vehicle of example 20, wherein the translucent vehicle body panel further comprises a layer of paint, the layer of paint coating the first internal surface with a controlled opacity.
26. The vehicle of example 20, wherein the translucent vehicle body panel further comprises metal plating, wherein the metal plating is bonded to the first internal surface.
27. The vehicle of example 20, wherein the translucent vehicle body panel further comprises reinforcements coupled to the exterior layer.
28. The vehicle of example 20, wherein the translucent vehicle body panel further comprises an interior layer having a second external surface and second internal surface, wherein the exterior layer and interior layer form a single continuous panel, wherein the single continuous panel is configured to allow light, from between the exterior layer and interior layer, or from behind the interior layer, to pass through exterior layer.
29. A method of fabricating a translucent vehicle body panel as disclosed herein.

What is claimed is:

1. A body panel, comprising:
a translucent panel having an interior surface and an exterior surface;
a light source attached to the interior surface; and
a color layer disposed on at least a portion of at least one of the interior surface and the exterior surface.

2. The body panel of claim 1, wherein the color layer is a paint layer.

3. The body panel of claim 2, wherein the paint layer has a thickness between approximately 0.0005 inches and approximately 0.050 inches.

4. The body panel of claim 3, wherein the paint layer has a thickness between approximately 0.001 inches and approximately 0.030 inches.

5. The body panel of claim 4, wherein the paint layer has a thickness between approximately 0.003 inches and approximately 0.015 inches.

6. The body panel of claim 1, wherein the color layer is a film.

7. The body panel of claim 1, wherein the light source comprises one or more light emitting diodes.

8. The body panel of claim 1, further comprising a reflective layer positioned inboard of the light source.

9. The body panel of claim 1, wherein the color layer is disposed on the exterior surface.

10. The body panel of claim 9, further comprising a blocking layer disposed between at least a portion of the color layer and the translucent panel.

11. A body panel, comprising:
a translucent panel having an interior surface and an exterior surface;
a color layer disposed on at least a portion of the interior surface; and
a light source positioned inboard of the color layer.

12. The body panel of claim 11, wherein the light source comprises an electro-illuminating layer.

13. The body panel of claim 12, further comprising a reflective layer positioned inboard of the electro-illuminating layer.

14. The body panel of claim 11, wherein the light source comprises a light emitting diode and an associated mount.

15. A vehicle body panel, comprising:
a curved translucent panel having an interior surface and an exterior surface;
a color layer disposed on at least a portion of the exterior surface;
a blocking layer positioned between at least a portion of the color layer and the panel; and
a light source attached to the interior surface.

16. The vehicle body panel of claim 15, wherein at least a portion of the panel is transparent.

17. The vehicle body panel of claim 15, wherein the curved translucent panel is configured as a vehicle fender.

18. The vehicle body panel of claim 15, wherein the curved translucent panel is configured as a vehicle bumper.

19. The vehicle body panel of claim 15, wherein the curved translucent panel is configured as a vehicle door.

20. The vehicle body panel of claim 19, wherein the blocking layer includes a plurality of openings.

21. A body panel, comprising:
a translucent core material having an interior surface and an exterior surface;
an interior face-sheet attached to the interior surface;
an exterior face-sheet attached to the exterior surface;
a color layer disposed on at least a portion of the exterior face-sheet; and
a light source positioned inboard of the exterior face-sheet.

22. The body panel of claim 21, wherein the light source is attached to the interior face-sheet.

23. The body panel of claim 21, wherein the light source is positioned between the interior face-sheet and the exterior face-sheet.

24. A body panel, comprising:
a transparent panel having an interior surface, an exterior surface, and at least one edge; and
a light source attached to the at least one edge;
wherein the transparent panel has an index of refraction such that light emitted from the light source travels along at least a portion of the panel.

25. The body panel of claim 24, wherein the transparent panel includes a curved portion that exceeds a maximum reflection angle of the panel whereby the light emitted from the light source travels through at least one of the interior and exterior surfaces.

26. The body panel of claim 24, further comprising a plurality of ridges embossed into at least one of the interior and exterior surfaces.

27. The body panel of claim 24, further comprising a first color layer disposed on the interior surface and a second color layer disposed on the exterior surface.
